(19) United States
(12) Patent Application Publication
(10) Pub. No.: US 2023/0097970 A1
(43) Pub. Date: Mar. 30, 2023

(54) SYSTEM, METHOD, APPARATUS, AND COMPUTER PROGRAM PRODUCT FOR A REAL ESTATE VALUATION

(71) Applicants: James Andrew Duda, II, Delran, NJ (US); Nikit Nainwal, Delran, NJ (US); Sal Arena, Delran, NJ (US)

(72) Inventors: James Andrew Duda, II, Delran, NJ (US); Nikit Nainwal, Delran, NJ (US); Sal Arena, Delran, NJ (US)

(21) Appl. No.: 17/936,958

(22) Filed: Sep. 30, 2022

Related U.S. Application Data
(60) Provisional application No. 63/261,842, filed on Sep. 30, 2021.

(51) Int. Cl. G06Q 50/16; G06Q 30/02

(52) U.S. Cl. CPC G06Q 50/163; G06Q 30/0205; G06Q 30/0201

(57) ABSTRACT

A process for generating a real estate valuation, the process including providing a server integrated with a multiple listing service database, a real estate transaction standard, and an internet data exchange, providing adjustment values for a property by input of a user, selecting a geographical location, preparing and executing a query of properties in the geographical location with similar adjustment values, weighting results of the query according to pre-determined metrics selected by the user, converting results into a linear algebra problem, using a weighted linear regression to determine adjustment values, determining if the adjustment values are reasonable, and generating a graphical user interface displaying the results.

### CROSS-REFERENCE TO RELATED APPLICATION

This application claims the benefit of priority of U.S. provisional application No. 63/261,842, filed Sep. 30, 2021, the contents of which are herein incorporated by reference.

### BACKGROUND OF THE INVENTION

The present invention relates to real estate valuations, and more particularly, to a system, method, apparatus, and computer program product for such.

Real estate professionals are often tasked with generating a valuation for a specific residential property or multiple residential properties. Many real estate valuations are based upon analyses of vendor data from a multiple listing service (MLS). However, data provided and extrapolated from these MLS databases are subjective, variable, and prone to human error.

Moreover, using an algorithm to generate a residential valuation is inaccurate and problematic. Many factors must be weighted and considered when evaluating a property, such as market influence, physical depreciation, functional and economic obsolescence. Many of these factors are not adequately assessed or measured by automated computer programs and require user input, specifically expert user input. Often, it is unclear which factors an automated valuation considers and the weight it places on each factor. This results in important factors, such as a specific quality or specific attributes of a home, being ignored or improperly weighted. Considering these data issues, automating the valuation process results in unsubstantiated valuations with a high degree of volatility and variability.

In addition, relying on automated programs for valuations often lead to issues with substantiating or supporting valuations. More often than not, the real estate professional cannot answer what specific factors contributed to said valuations.

Accordingly, what is needed is a system, method, apparatus, or computer program product that provides for a more objective and supportive valuation of real estate property.

### SUMMARY OF THE INVENTION

In one aspect of the present invention, a process and system for generating a real estate valuation, the process includes providing a server integrated with a multiple listing service database, a real estate transaction standard, and an internet data exchange, providing user specific adjustment values for a property, selecting a geographical location, preparing and executing a query of properties in the geographical location with similar adjustment values, weighting results of the query according to pre-determined metrics selected by the user, converting results into a linear algebra problem, using a weighted linear regression to determine adjustment values, determining if the adjustment values are reasonable, and generating a graphical user interface displaying the results.

Advantageously, rather than relying on an automated appraisal program, the user now can use a valid approach for a valuation. The present invention offers rapid insight and knowledge into markets in a specific area. The present invention utilizes the user's expertise to provide an optimal output by relying on the user's information and knowledge on a property and data for such for processing of the valuation.

The present invention offers a valuation with supporting evidence rather than just an arbitrary value without any justification.

These and other features, aspects and advantages of the present invention will become better understood with reference to the following drawings, description, and claims.

### BRIEF DESCRIPTION OF THE DRAWINGS

FIG. 1 is a flow chart illustrating an adjustment of a value determination; and

FIG. 2 is a flow chart illustrating a sales comparison evaluation.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims with reference to the drawings.

A general overview of the various features of the invention will be provided, with a detailed description following. Broadly, an embodiment of the present invention provides a system, method, apparatus, and computer program product that guides each step of a valuation process, scrutinizing the data, and optionally editing data, for an optimal valuation and range of value for a real estate property.

The present invention provides the user the authority and control of each step of the valuation process. An output of the process reflects the user's knowledge and expertise and the user's control and input. The system provides the user with a mechanism to control input and variables at each step in the valuation process. It also provides the user an opportunity to edit variables or data, such as sales used in a valuation or data within the sales themselves, to achieve an optimal valuation.

The present invention may produce a report, savable as a PDF or another digital format for print or digital file transfers and/or communication between parties.

Aspects of the present invention may include integration with or of a vendor's database such as a multiple listing service (MLS), a real estate transaction standard (RETS), and/or internet data exchange (IDX). The present invention may further include a login screen, an identification of a region or area, an option to review or add a listing, an option to review a sale or sales, an option to select adjustments and/or edit data, an option to evaluate a listing, and an option to view a detailed report.

A multiple listing service (MLS) may provide a RETS or an IDX and integrate the data into a server of the present invention. A user may log in to the server. The server may be a cloud-based site. A region, area, or time frame may be selected for use in a valuation. The user may review/identify volatility of specific sales, markets, sub-markets, and sales price ranges. The user may select adjustments depending on data reviewed/identified and edit adjustments. The user may further find comparable sales based on selected parameters and view a detailed report to further scrutinize comparable sales, remove, add, or replace data where necessary or deemed appropriate and edit data for accuracy.

Data, such as data from an MLS vendor, may be integrated on a cloud-based website and provided to the user via a simplified user interface. Certain website features have default values and features that the user can edit. A Review Sales subroutine may organize the data based on the criteria selected by the user. The organized data may be displayed on a Sales Page. The user may interact with the interface to decline or approve sales to be used in an evaluation while simultaneously analyzing various aspects of the database based on specific attributes.

An Evaluate subroutine may utilize logic functions to identify properties with similar attributes depending on parameters selected by the user. If no result or less than optimal results are found, the user can soften or amend a parameter and run the Evaluate subroutine again until optimal results are found. The result can be further analyzed and edited using a Detailed Report. These revisions may include deletion, addition or replacement of specific sales as well as specific data point amendments to achieve the optimal result.

The Review Sales subroutine may analyze an MLS database and provide an interface which provides the user with various analytical information related to the MLS region/area selected. The Evaluate subroutine analyzes the specific property or properties identified on the Search page using if-then relationships to find anywhere from one to five sales of comparison while at the same time applying the adjustments selected for varying attributes to provide the user with an optimal valuation.

In some embodiments of the present invention, the system and application may be built on a cloud-based web platform to allow for database integration. The database integration may be approved and authorized by its respective vendor. The database may then be read from the server and displayed to the user via a user interface consisting of separate but connected tabs, sections, or pages. An Adjustment tab may be propagated with default values that the user can over-ride or edit. The values on this tab are applied mathematically to the process during the Evaluate subroutine. A New Listing tab enables a user to edit or create a new listing. In the New Listing process, the user provides property information such as square footage, sales price, number of bathrooms, location, etc, and the server creates a property in our database that can be accessed by this user only for use in sales comparison. The user may elect to provide all the information from scratch, or they may use Load From Address to get information from a recent listing of that property and edit that information. The purpose of this is to allow users to use sales information that may not yet be in vendor databases, as well as to allow users to change property information that they judge incorrect. A Load From Address subroutine searches and fetches information if it is in the database. The user may provide either an MLS number (a unique identifier) or an address, and our system finds the information for the relevant property. A Search tab identifies which property or properties are going to be evaluated and the user-controlled parameters that use logic functions to find optimal results. This tab also enables the user to access the Review Sales and Evaluate subroutines. The Sales tab is activated after the user selects the Review Sales subroutine. This routine then searches, fetches, and organizes the data on the Sales tab interface for review and analysis. A Results tab is activated when the Evaluate subroutine is selected. On the Results tab, the results of the Evaluate subroutine are displayed. A Detailed Page displays the result in a sales comparison grid or comparative market analysis that can be further edited or changed to maximize optimal results.

The system may generate a graphical user interface (GUI) or a tab within the graphical user interface to display results wherein the user may edit or override those results. It may generate a GUI or tab identifying properties to be weighted wherein the properties may be weighted by user parameters. It may generate a GUI or tab displaying a comparative market analysis. It may generate a GUI or a tab wherein the user may add a new property to be weighted not in the database. It may generate a query by selection of a property by the user in the database.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

According to an embodiment of the present invention, a search or a valuation of a home comprises a selection of a market and adjustment values. Markets and adjustment values may be subjective and flexible. Thus, a user's experience and knowledge are beneficial. A market may include a geographical location and a time frame or time period, including past, present, or future time periods. The search and/or valuation may be narrow and include data of similar homes/properties in the same or neighboring neighborhoods. These homes/properties may be of a similar age, style, size, and/or other categories. If the results are not satisfactory, the parameters may be tightened or loosened. For example, a user may adjust parameters or metrics in the initial search. For example, a size differential of the initial search may be plus/minus 250 square feet. The size differential in an adjusted search may be plus/minus 500 square feet.

An “adjustment” may be a difference between similar properties to which a monetary value is assigned. For example, a bathroom is an adjustment, and a user may assign one bathroom a value of $3000. Then, if the user is trying to estimate the value of property X, and property X is approximately the same as property Y except for having one extra bathroom, the present invention may estimate the value of property X as $3000 more than property Y's sales value. “User adjustment values” is the set of monetary values the user wants to use. For example, the user may want to assign a bathroom a value of $2000 and a finished basement a value of $10000.

A filter may be a restriction on the comparable sales a user might use to find the value of a specific property. One example filter is “same building class”, which means that when the user is looking for comparable sales to estimate the value of property X, the present invention may only look for properties that have the same building class as property X. Initially, the user might turn on “same building class”, and the server will return only comparable sales that are of the same building class. They may then observe that some properties do not have enough comparable sales. They can save the property assessments for which there are enough comparable sales, and then turn off “same building class” and rerun evaluation. For only the portion of the properties that did not have enough comparable sales of the same building class, the server will find comparable sales that might not have the same building class. After the user selects properties to evaluate, the user selects may filter to specify what types of properties may be used as comparable sales.” The filters may be as follows: Sales code of comparable sale; Date range of comparable sale; VCS of comparable property; Difference in age of assessed property and comparable property; Age of comparable property; Difference in square footage of assessed property and comparable property; Size of comparable property; Whether or not the assessed property and comparable property are in the same zone; Whether or not the assessed property and comparable property have the same building class; Whether or not the assessed property and comparable property have the same type/use code; Whether or not the assessed property and comparable property have the same style code; Whether or not the assessed property and comparable property have the same story height; Whether or not the assessed property and comparable property have the same view code; and Limits on the total size of an individual adjustment, net total adjustments, or gross total adjustments applied to the comparable sale.

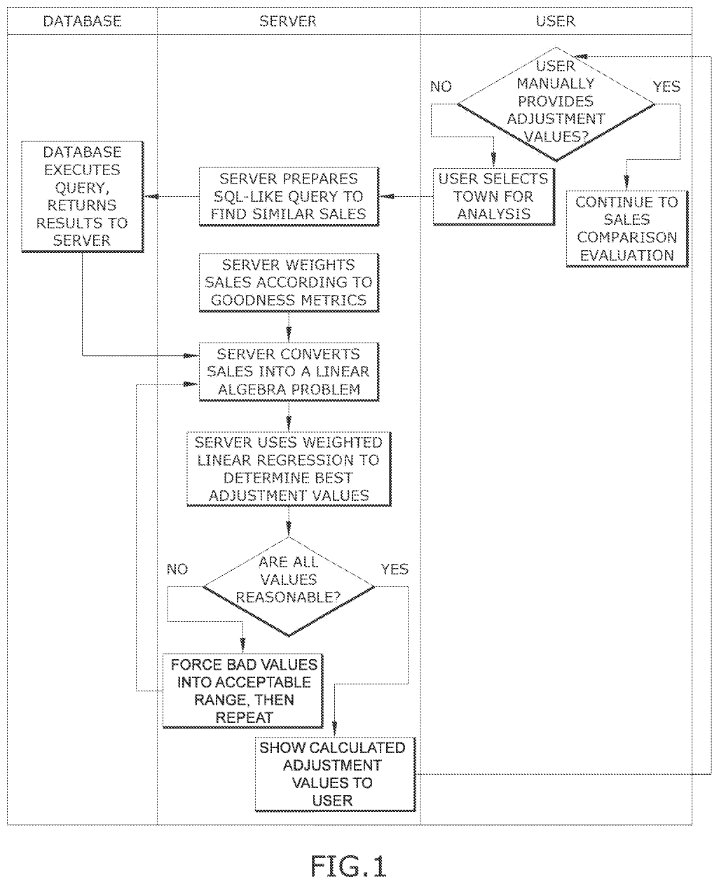

Referring to the Figures, FIG. 1 details an adjustment of a value determination by an integration of a database with a platform of the present invention according to an embodiment of the present invention. It may detail a process for filling out values on an Adjustment tab.

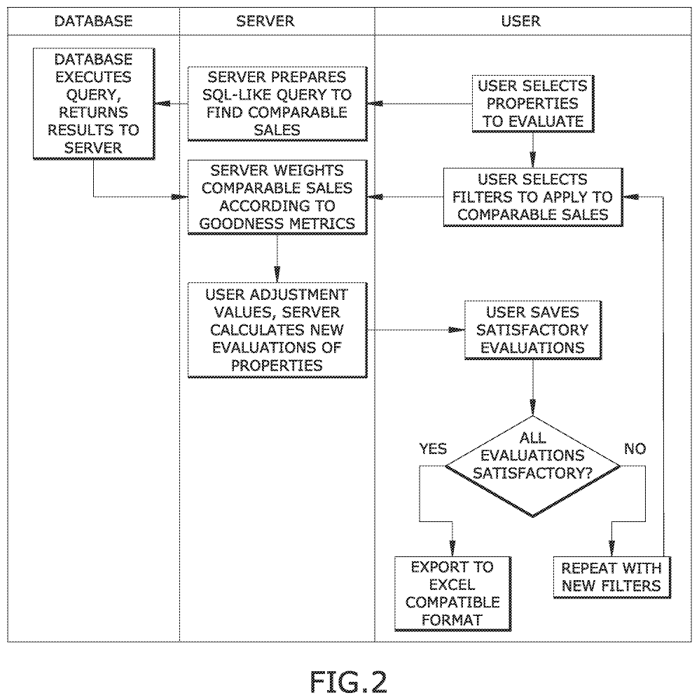

A user may manually provide adjustment values. If the user does, the sales comparison evaluation described in FIG. 2 is utilized. If the user does not provide adjustment values, the user selects a geographical location, such as a town for analysis. The server then prepares a query to find similar sales. The query may comprise a request for data or information from the MLS database table or combination of tables to find similar sales. The database executes the query and provides results to the server. The server weights sales according to metrics selected by the user and may filter results by the weights. The metrics may be net adjustments applied to comparable sale, age of comparable sale, and a difference between the comparable sale's sales price and its assessment value. The server then utilizes the results from the computation of weighted sales to convert sales into a linear algebra problem and uses a weighted linear regression to determine adjustment values. If the values are not reasonable based on the search parameters selected, global values are amended to get localized values, and the data is then converted into a linear algebra problem. If the values are reasonable based on the user's search parameters, some values (bad values) may be ignored, and some values (good values) may be selected. The selected values may be the most similar values, for example, the five most similar values may be selected. The bad values are forced into an acceptable range. The data is then converted into a linear algebra problem and the results are displayed on a graphical user interface for the “Results and Details” Tab.

SQL is a method of describing a set of elements that you are looking for in a database. The present invention is not limited to such a method as the present invention may substitute this step with any method sufficient to prepare a query to find similar sales based on the specifications provided by the user in the Search tab.

Prior to the method steps of FIG. 1, a user may log in and select a geographical location for a calculation of property values.

FIG. 2 details a sales comparison evaluation by the platform according to an embodiment of the present invention for an Evaluate subroutine. The user selects properties to evaluate. The server prepares a query to find comparable sales. The database executes the query and provides results to the server. The query may comprise a request for data or information from the MLS database table or combination of tables to find similar sales. The user selects a filter to apply for comparable sales. The server weighs comparable sales according to metrics and filters selected by the user. User adjustment values, such as monetary adjustment values for specific home attributes (square footage, number of bathrooms, number of bedrooms), are established by the user and then the server applies positive or negative adjustments to calculate new evaluations of selected properties. The server calculates new evaluations of selected properties. The user saves satisfactory evaluations. If all evaluations are satisfactory, the evaluations may be exported in a readable format. If the evaluations are not satisfactory, the user may select a filter to apply comparable sales again for the server to weigh and repeat a portion of the process. For example, if the user is not satisfied with the evaluation result set or not enough sales are found for a confident evaluation, the user can edit search parameters and/or sales to be utilized in the search until a sufficient number of sales has been established or until the user finds the results acceptable. If the user is satisfied with the evaluation or all evaluations, the data may be exported and/or displayed.

A search tab may provide details for the evaluate subroutine. Specifically, users may fill out the Search tab to detail which properties they are selecting. A Results tab and a Details Page tab may show information specifically from the “user adjustment values, server calculates new evaluation of properties.”

It should be understood, of course, that the foregoing relates to exemplary embodiments of the invention and that modifications may be made without departing from the spirit and scope of the invention as set forth in the following claims.

What is claimed is:

1. A process for generating a real estate valuation, the process comprising:
providing a server integrated with a multiple listing service database, a real estate transaction standard, and an internet data exchange;
providing adjustment values for a property by input of a user;
selecting a geographical location;
preparing and executing a query of properties in the geographical location with similar adjustment values;
weighting results of the query according to pre-determined metrics selected by the user;
converting results into a linear algebra problem;
using a weighted linear regression to determine adjustment values;
determining if the adjustment values are reasonable; and
generating a graphical user interface displaying the results.

2. The process of claim 1 further comprising, generating a tab to display the results wherein the user may override the results.

3. The process of claim 1 further comprising, generating a tab identifying properties to be weighted wherein the properties may be weighted by user parameters.

4. The process of claim 1 further comprising, generating a tab displaying a comparative market analysis wherein the comparative market analysis may be edited.

5. The process of claim 1 further comprising, generating a tab wherein the user may add a new property to be weighted not in the multiple listing service database.

6. The process of claim 1 further comprising, generating a query by selection of a property by the user in the database.
